(19) United States
(12) Patent Application Publication
(10) Pub. No.: US 2026/0342256 A1
(43) Pub. Date: Oct. 29, 2026

(54) METHOD FOR CONTROLLING CURRENTS OF PERMANENT MAGNET SYNCHRONOUS MOTORS BASED ON CONSTRAINED MODEL PREDICTIVE CONTROL

(71) Applicant: SPINTROL ELECTRONIC TECHNOLOGY (SHANGHAI) CO., LTD., Shanghai (CN)

(72) Inventors: Tao LI, Shanghai (CN); Mingming ZHANG, Shanghai (CN); Jun ZHANG, Shanghai (CN); Binyu XIA, Shanghai (CN)

(21) Appl. No.: 19/120,617

(22) PCT Filed: Nov. 3, 2022
(86) PCT No.: PCT/CN2022/129516

§ 371 Date: Apr. 11, 2025

(30) Foreign Application Priority Data
Oct. 12, 2022 (CN) 202211249061.2

(51) Int. Cl. H02P 21/22

(52) U.S. Cl. CPC H02P 21/22; H02P 2207/05

(57) ABSTRACT

A method for controlling currents of a permanent magnet synchronous motor based on constrained model predictive control is provided. The stator current measurement data of the permanent magnet synchronous motor at sampling time are obtained; a current following error signal is generated based on the stator current measurement data and a stator current set value; it is determined whether an area where the current following error signal is located in a current plane state partition is a hexagonal interior area, a first area or a second area; in response to determining that the area where the current following error signal is located in the current plane state partition is the first area, the current following error signal is mapped to a side of the first area to obtain an updated current following error signal; and a current loop control voltage is generated. An analytical expression of the predictive control rate at the current control time is provided in accordance with the system state, to overcome the defect of massive online computation work in the traditional constrained predictive control algorithm and further lower the requirements for the chip computing power.

### FIELD

Embodiments of the present disclosure generally relate to the field of current loop control of permanent magnet synchronous motors, and more specifically, to a method for controlling currents of permanent magnet synchronous motors based on constrained model predictive control.

### BACKGROUND

Motors convert electric energy into mechanical energy, which is the most important motive power in modern industry. Motors consume 60%-70% of the total energy consumption in the industry, so it is of vital importance to enhance their control efficiency.

Traditionally, motor control includes inner loop control and outer loop control, wherein the inner loop control refers to current loop control, which is the control over electric signals; and the outer loop control indicates mechanical control, which is the control over mechanical signals. The controls over electric signals and mechanical signals vary greatly in time dimension. Usually, the time scale corresponding to the control over electric signals is in millisecond while the time scale corresponding to the control over mechanical signals is in second. Therefore, in order to effectively control the motors, the electromechanical control is divided hierarchically into inner and outer loops.

The current loop control problem, in tradition, is dealt with mainly by a decoupling PI (Proportion and Integration) method. However, such PI control method is slow in dynamic response. In particular, when a rapid control is in need, it always causes integral saturation on the PI controller and system overshoot. As a result, the system slowly goes into the steady state and the corresponding control bandwidth can hardly reach a high level.

Constrained Model Predictive Control (MPC), when applied into the current loop control, can implement quick control. However, the traditional MPC needs to solve complicated optimization problems online in real time and involves massive computation work. In order to complete the computation within a short sampling interval, high-performance chips should be used, which may lead to high costs. Industrially, the traditional MPC, restricted by hardware costs, can hardly implement the control at high switching frequency.

In summary, at present, the MPC technique, if applied into the current loop control, usually involves massive computation work, which may further lead to difficult implementation and high costs.

### SUMMARY

For the above issue, the present disclosure provides a method for controlling currents of a permanent magnet synchronous motor based on constrained model predictive control and a computing device for applying the predictive control theory into the current loop control of the permanent magnet synchronous motor, so as to achieve high bandwidth control over the motor currents. The present disclosure provides an analytical expression of the predictive control rate at the current control time in accordance with the system state, to significantly reduce the consumption of operational resources and overcome the defect of massive online computation work in the traditional constrained predictive control algorithm. The algorithm designed in the present disclosure may be implemented on low-cost chips.

In accordance with a first aspect of the present disclosure, there is provided a method for controlling currents of a permanent magnet synchronous motor based on constrained model predictive control. The method comprises: obtaining stator current measurement data of the permanent magnet synchronous motor at sampling time; generating a current following error signal based on the stator current measurement data and a stator current set value; determining whether an area where the current following error signal is located in a current plane state partition is a hexagonal interior area, a first area or a second area, the current plane state partition including the hexagonal interior area and the first area and the second area surrounding the hexagonal interior area; in response to determining that the area where the current following error signal is located in the current plane state partition is the first area, mapping the current following error signal to a side of the first area to obtain an updated current following error signal; and generating, based on the updated current following error signal, a current loop control voltage for controlling a stator current of the permanent magnet synchronous motor, to cause the stator current of the permanent magnet synchronous motor to track a reference current.

In some embodiments, the method for controlling currents of a permanent magnet synchronous motor based on constrained model predictive control further comprises: in response to determining that the area where the current following error signal is located in a current plane state partition is the second area, obtaining the updated current following error signal based on a vertex where corresponding two sides of a hexagonal interior area intersect, to generate the current loop control voltage for controlling the stator current of the permanent magnet synchronous motor.

In some embodiments, the method for controlling currents of a permanent magnet synchronous motor based on constrained model predictive control further comprises: in response to determining that the area where the current following error signal is located in the current plane state partition is the hexagonal interior region, generating the current loop control voltage for controlling the stator current of the permanent magnet synchronous motor based on the current following error signal, to cause the stator current of the permanent magnet synchronous motor to track the reference current.

In some embodiments, generating the current loop control voltage for controlling the stator current of the permanent magnet synchronous motor comprises: generating, based on the updated current following error signal, the current loop control voltage for controlling the stator current of the permanent magnet synchronous motor, via an analytical solution to a current loop control corresponding to a discrete model of the permanent magnet synchronous motor.

In some embodiments, the analytical solution to the current loop control corresponding to the discrete model of the permanent magnet synchronous motor is determined by: constructing the discrete model of the permanent magnet synchronous motor; performing variable substitution on the discrete model with stator current following error as state variable and stator voltage following error as control input, to transform the discrete model into a linear time-invariant model in relation to the state variable and the control input; and determining the analytical solution to the current loop control corresponding to the discrete model of the permanent magnet synchronous motor in accordance with predetermined constraint conditions, a target function and the linear time-invariant model.

In some embodiments, the predetermined constraint conditions include constraint conditions with respect to an original voltage of the permanent magnet synchronous motor, a steady-state voltage of the permanent magnet synchronous motor, a bus voltage of the permanent magnet synchronous motor and a penalty matrix of the control input.

In some embodiments, the first area comprises six first sub-areas being perpendicular to sides of the hexagonal interior area and extending towards outside of the hexagonal interior area respectively, and the second area comprises six second sub-areas separated by the six first sub-areas respectively.

In some embodiments, the stator current set value comprises steady-state current data of the permanent magnet synchronous motor.

In some embodiments, a system state matrix and an input matrix of the discrete model of the permanent magnet synchronous motor are both scaling rotation matrices.

In accordance with a second aspect of the present disclosure, there is provided a computing device, comprising at least one processor; and a memory communicatively connected to the at least one processor; wherein the memory stores instructions that can be executed by the at least one processor, the instructions, when executed by the at least one processor, causing the at least one processor to perform the method according to the first aspect of the present disclosure.

In accordance with a third aspect of the present disclosure, there is provided a computer-readable storage medium stored thereon with computer programs, the computer programs, when executed by a processor, implementing the method according to the first aspect of the present disclosure.

It should be appreciated that the contents described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description with reference to the accompanying drawings, the above and other features, and advantages of the various embodiments of the present disclosure will become more apparent. In the drawings, same or similar reference signs indicate same or similar elements.

FIG. 1 illustrates a schematic diagram of a computing device for implementing the method for controlling currents of permanent magnet synchronous motors based on constrained model predictive control in accordance with embodiments of the present disclosure;

FIG. 2 illustrates a flowchart of the method for controlling currents of permanent magnet synchronous motors based on constrained model predictive control in accordance with embodiments of the present disclosure;

FIG. 3 illustrates a schematic diagram of the current plane state partition in accordance with the embodiments of the present disclosure;

FIG. 4 illustrates a schematic diagram in which the current following error signal is located in the first area in accordance with the embodiments of the present disclosure;

FIG. 5 illustrates a schematic diagram in which the current following error signal is located in the second area in accordance with the embodiments of the present disclosure;

FIG. 6 illustrates a flowchart of a method for determining an analytical solution to the current loop control corresponding to the discrete model of the permanent magnet synchronous motor in accordance with embodiments of the present disclosure;

FIG. 7 illustrates a schematic diagram of the current plane state partition in accordance with embodiments of the present disclosure;

FIG. 8 illustrates another schematic diagram of the current plane state partition in accordance with embodiments of the present disclosure;

FIG. 9 illustrates a further schematic diagram of the current plane state partition in accordance with embodiments of the present disclosure;

FIG. 10 illustrates a schematic block diagram of an example electronic device for implementing the method for controlling currents of permanent magnet synchronous motors based on constrained model predictive control in accordance with embodiments of the present disclosure.

### DETAILED DESCRIPTION OF EMBODIMENTS

Example embodiments of the present disclosure are to be explained below with reference to the drawings, including various details of the embodiments of the present disclosure to facilitate understanding. Such explanation should be considered as exemplary. Those skilled in the art should recognize that various changes and modifications may be made to the embodiments described herein without deviating from the scope and the spirit of the present disclosure. Also, the known functions and structures are not depicted in the following description for clarity and conciseness.

The term “includes” and its variants used herein are to be read as open-ended terms that mean “includes, but is not limited to.” Unless indicated otherwise, the term “or” is to be read as “and/or”. The term “based on” is to be read as “based at least in part on.” The term “one example embodiment” and “one embodiment” are to be read as “at least one example embodiment.” The term “a further embodiment” is to be read as “at least one further embodiment”. The terms “first”, “second” and so on can refer to same or different objects. The following text also may include other explicit and implicit definitions.

As previously described, MPC technology is used in the current loop control and usually involves quite massive computation work. To facilitate description, a surface-mounted permanent magnet synchronous motor is taken as an example to be described below. It is to be understood that the technical solution of the present disclosure also applies to various types of permanent magnet synchronous motors, such as embedded permanent magnet synchronous motor. A mathematical model of the surface-mounted permanent magnet synchronous motor is shown in Equation (1):

$$\frac{d}{dt} \text{?} = \text{?} ( t ) + \text{?} ( t ) + \text{?} \qquad ( 1 )$$

$$\text{?} \text{indicates text missing or illegible when filed}$$

### Where

$${A}_{c} = [ \begin{matrix}- \frac{{R}_{s}}{{L}_{s}} & ω \\ - ω & \frac{{R}_{s}}{{L}_{s}}\end{matrix} ] , {B}_{c} = \frac{1}{{L}_{s}} [ \begin{matrix}1 & 0 \\ 0 & {1}_{s}\end{matrix} ] , {g}_{c} = [ \begin{matrix}0 \\ - \frac{ω}{{L}_{s}}\end{matrix} ] {ψ}_{f} , \text{?}$$

$$\text{?} \text{indicates text missing or illegible when filed}$$

characterizes derivation of the variable t (indicating time); iₛ represents the stator current of the permanent magnet synchronous motor; uₛ denotes the stator voltage of the permanent magnet synchronous motor; Rₛ is the resistance of the permanent magnet synchronous motor; Lₛ characterizes the inductance of the permanent magnet synchronous motor; Ψⱼ indicates the permanent magnet flux linkage parameter of the permanent magnet synchronous motor; ω denotes the rotation rate of the permanent magnet synchronous motor; and Tₛ represents the sampling time of the permanent magnet synchronous motor.

According to the continuous dynamic equation shown in the Equation (1), a discrete model of the permanent magnet synchronous motor is generated in a two-phase rotating coordinate system. The discrete model is illustrated in Equation (2):

iₛ(k+1)=Fiₛ(k)+Biₛ(k)+g (2)

### Where

$$F = {e}^{{A}_{c} {T}_{s}} , B = {A}_{c}^{- 1} ( {e}^{{A}_{c} {T}_{s}} - I ) {B}_{c} , g = {A}_{c}^{- 1} ( {e}^{{A}_{c} {T}_{s}} - I ) {g}_{c} ;$$

F denotes the system matrix; B indicates the input matrix; I characterizes the unit matrix; and k refers to the k-th sampling time, k being an integer greater than or equal to 0.

To implement the current loop control, it is required to design a current controller, i.e., the stator current iₛ(t) is controlled to track the reference current

$$\text{?} ( t ) .$$

$$\text{?} \text{indicates text missing or illegible when filed}$$

In the frame of the model predictive control theory, the tracking issue may be described as an optimization problem illustrated in Equation (3) below:

$$min \text{?} = \text{?} Q \text{?} + \text{?} R \text{?} \qquad ( 3 )$$

$$\begin{matrix}s . t . & \text{?} = \text{?} = 0 , 1 , … , Np - 1 \\ & \begin{matrix}\text{?} = 0 , 1 , … , Np - 1\end{matrix} \\ & \text{?} = 0 , 1 , … , \text{?} - 1 \\ & \text{?} = \text{?}\end{matrix}$$

$$\text{?} \text{indicates text missing or illegible when filed}$$

Where min indicates the minimum value; s.t. represents the constraints; J₀ is the target function ũ; represents the steady-state voltage of the permanent magnet synchronous motor; iₖ refers to the stator current of the permanent magnet synchronous motor at the k-th sampling time; ī is the steady-state current of the permanent magnet synchronous motor; (iₖ−i) denotes the current following error of the permanent magnet synchronous motor at the k-th sampling time; Q represents a weight matrix of the current following error; uₖ denotes the stator voltage of the permanent magnet synchronous motor at the k-th sampling time; ũ is the steady-state voltage of the permanent magnet synchronous motor; i₀ indicates an initial value of the stator current of the permanent magnet synchronous motor; R is a real number field; Nₚ represents the predicted step; and Nᵤ is the control step.

It requires heavy computation work to solve the Equation (3). In order to complete the computation within a short sampling interval, it is required to use a high-performance chip. In such case, it is difficult to carry out the implementation and the costs are high.

To at least partly solve one or more of the above and other potential problems, example embodiments of the present disclosure provide a solution for controlling memory access. In this solution, stator current measurement data of the permanent magnet synchronous motor at the sampling time are first obtained. Then, the current following error signal is generated based on the stator current measurement data and the stator current set value. The stator current measurement data are converted into the current following error signals to simplify the computation and rapidly determine the area where the current following error signal is located. It is determined whether the area where the current following error signal is located in a current plane state partition is a hexagonal interior area, a first area or a second area, wherein the current plane state partition includes the hexagonal interior area, and the first area and the second area surrounding the hexagonal interior area. If it is determined that the area where the current following error signal is located in the current plane state partition is the first area, the current following error signals are mapped to a side of the first area to obtain the updated current following error signals. When the updated current following error signals are obtained by mapping the current following error signals to a side of the first area, the algorithm for obtaining the updated current following error signals can be effectively simplified, the computation amount is reduced and the efficiency is enhanced. Afterwards, the current loop control voltage for controlling the stator current of the permanent magnet synchronous motor is generated based on the updated current following error signals, to cause the stator current of the permanent magnet synchronous motor to track the reference current. Therefore, the computation amount required for obtaining the current loop control voltage is significantly reduced, the related computation can be completed within a short sampling interval, and the use of the computation resources is greatly decreased.

In the following text, specific examples of the present solution are to be described in more details below with reference to the drawings.

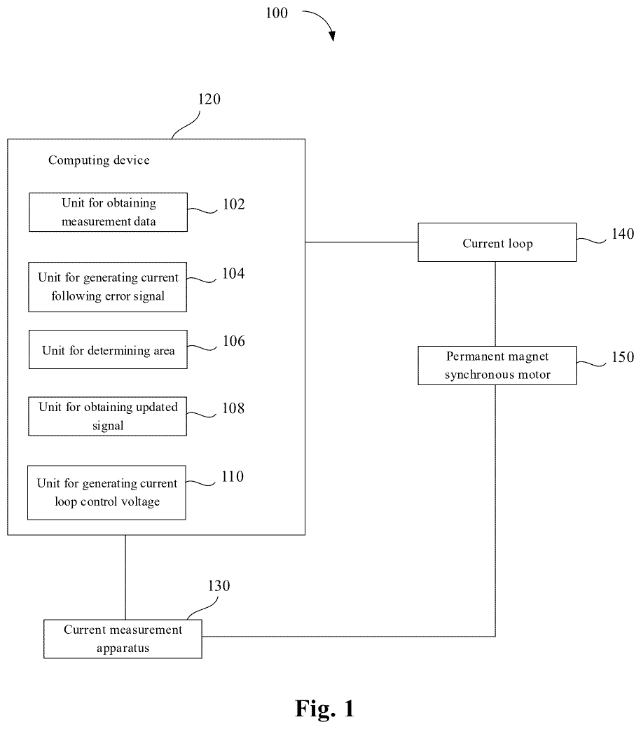

FIG. 1 illustrates a schematic diagram of a control system 100 for implementing the method for controlling currents of permanent magnet synchronous motors based on constrained model predictive control in accordance with embodiments of the present disclosure. The control system 100, for example, includes a computing device 120, a current measurement apparatus 130, a current loop 140 and a permanent magnet synchronous motor 150. The computing device 120, for example, performs the method for controlling currents of permanent magnet synchronous motors based on constrained model predictive control in accordance with embodiments of the present disclosure, so as to generate a current loop control voltage for controlling a stator current of the permanent magnet synchronous motor and further allow the stator current of the permanent magnet synchronous motor to track the reference current; the current measurement apparatus 130, for example, measures the permanent magnet synchronous motor 150 to obtain the stator current measurement data of the permanent magnet synchronous motor; the current loop 140, for example, receives a current loop control voltage output by the computing device 120, so as to control the permanent magnet synchronous motor 150.

The computing device 120 may comprise one or more processing units, including dedicated processing units, such as GPU (Graphics Processing Unit), FPGA (Field Programmable Gate Array) and ASIC (Application Specific Integrated Circuit), and universal processing units like CPU (Central Processing Unit). Besides, one or more virtual machines also may run on each computing device 120. In some embodiments, the computing device 120, for example, includes a unit for obtaining measurement data 102, a unit for generating current following error signal 104, an area determining unit 106, a unit for obtaining updated signal 108 and a unit for generating current loop control voltage 110. It is to be appreciated that the computing device 120 shown in FIG. 1 is just an example and shall not restrict the functions fulfilled by the present disclosure and the scope of the present disclosure.

The unit for obtaining measurement data 102 is used to obtain the stator current measurement data of the permanent magnet synchronous motor at the sampling time. The unit for obtaining measurement data 102, for example, receives the measured stator current measurement data of the permanent magnet synchronous motor from the current measurement apparatus 130.

The unit for generating current following error signal 104 is provided for generating current following error signals based on the stator current measurement data and the stator current set value.

The area determining unit 106 determines whether the area where the current following error signal is located in the current plane state partition is a hexagonal interior area, a first area or a second area, the current plane state partition including the hexagonal interior area and the first area and the second area surrounding the hexagonal interior area.

The unit for obtaining updated signal 108, in response to determining that the area where the current following error signal is located in the current plane state partition is the first area, maps the current following error signals to a side of the first area to obtain the updated current following error signals.

The unit for generating current loop control voltage 110 generates the current loop control voltage for controlling the stator current of the permanent magnet synchronous motor based on the updated current following error signals, to cause the stator current of the permanent magnet synchronous motor to track the reference current.

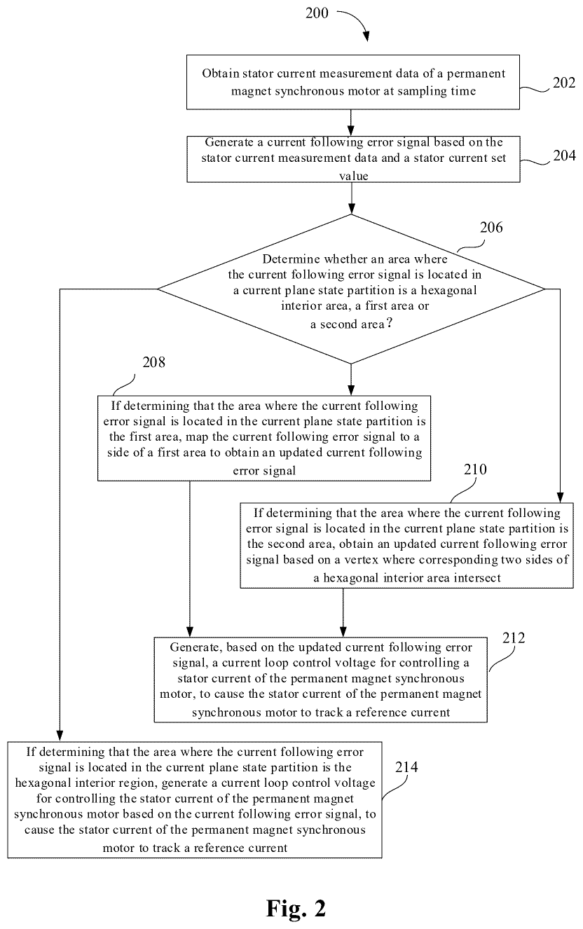

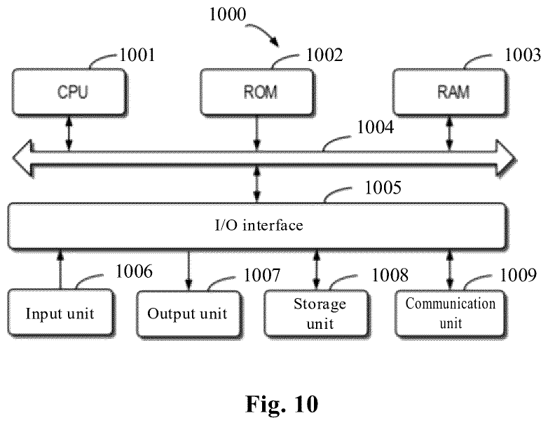

The method for controlling currents of permanent magnet synchronous motors based on constrained model predictive control in accordance with embodiments of the present disclosure is depicted in details below with reference to FIGS. 2-5. FIG. 2 illustrates a flowchart of the method 200 for controlling currents of permanent magnet synchronous motors based on constrained model predictive control in accordance with embodiments of the present disclosure. The method 200 may be executed by the computing device 120 shown in FIG. 1 and also may be performed at an electronic device 1000 shown in FIG. 10. It is to be understood that the method 200 also may include additional steps not shown and/or omit the illustrated steps. The scope of the present disclosure is not restricted in this regard.

At step 202, the computing device obtains the stator current measurement data of the permanent magnet synchronous motor at the sampling time, wherein the stator current measurement data for example is characterized by iₖ.

At step 204, the computing device generates current following error signals based on the stator current measurement data and the stator current set value.

In some embodiments, the stator current set value, for example, is the steady-state current of the permanent magnet synchronous motor, represented by ī; the current following error signal xₖ for example is the stator current following error signal iₖ−ī, i.e., xₖ=iₖ−ī.

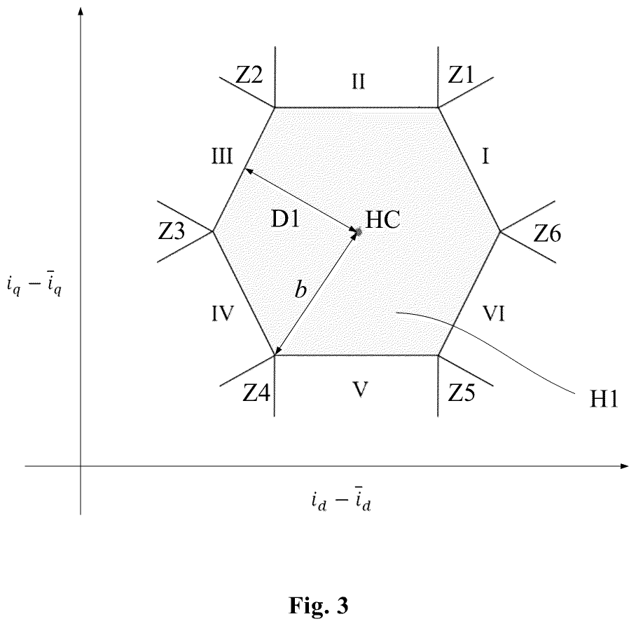

At step 206, the computing device determines that the area where the current following error signal is located in the current plane state partition is a hexagonal interior area, a first area or a second area. The current plane state partition includes the hexagonal interior area and the first area and the second area surrounding the hexagonal interior area. FIG. 3 illustrates a schematic diagram of the current plane state partition in accordance with the embodiments of the present disclosure. It should be appreciated that the current plane state partition is built on the basis of a two-phase rotating coordinate system as illustrated in FIG. 3. The current plane state partition includes the hexagonal interior area H1 and the first area and the second area surrounding the hexagonal interior area H1, where the hexagonal interior area H1 is defined by the following Equation (4):

$$\text{?} < \text{?} = \text{?} \frac{\sqrt{3}}{2} b 1 \qquad ( 4 )$$

$$\text{?} \text{indicates text missing or illegible when filed}$$

Where Aᵤ∈ [symbol] ^{6×2} and

$$\begin{matrix}\text{?} = \text{?} \\ = \text{?} \\ = \text{?}\end{matrix}$$

$$And \text{?} = \frac{\sqrt{3}}{2} b 1 , b = \frac{2}{3} \text{?} .$$

$$\text{?} \text{indicates text missing or illegible when filed}$$

It should be appreciated that b represents a radius of a circumcircle of the hexagonal interior area H1; 1 indicates a column vector with elements all being 1; V_{dc} denotes a bus voltage of the permanent magnet synchronous motor; s_{B} is the scaling factor corresponding to the input matrix B; θ_{B} characterizes the feature rotating angle of the input matrix B; Tₛ refers to the sampling time of the permanent magnet synchronous motor; R is a penalty matrix; θᵣ represents the rotor angle of the permanent magnet synchronous motor;

$${p}_{1} = {r}^{2} {s}_{F}^{4} + {r}^{2} {s}_{F}^{2} + 2 {rs}_{F}^{2} + {( r + 1 )}^{2} ;$$

r indicates a penalty weight for the control input; s_{F} refers to the scaling factor of the system matrix F; d_{H} denotes a square root of a determinant of an inverse matrix H⁻¹ of the matrix; ū is the steady-state voltage of the permanent magnet synchronous motor. It is to be appreciated that each line of Aᵤ, i.e.,

$$\text{?} ( k = 0 , … , 5 ) ,$$

$$\text{?} \text{indicates text missing or illegible when filed}$$

defines each side of the hexagonal interior area H1 separately. It is to be understood that the hexagon is a regular hexagon in some embodiments.

The center HC of the hexagonal interior area H1 is defined by the following Equation (5):

$$\overline{i} + \frac{{s}_{B} {d}_{H}}{\text{?} {s}_{F}} R ( ω \text{?} + {θ}_{B} ) \overline{u} = \overline{i} + \frac{{d}_{H}}{\text{?}} {F}^{- 1} B \overline{u} \qquad ( 5 )$$

$$\text{?} \text{indicates text missing or illegible when filed}$$

Where F⁻¹ represents an inverse matrix of the system matrix F.

In the hexagonal interior area H1, a distance D1 from the center HC to each side is defined by the following Equation (6):

$$D 1 = \frac{{s}_{B} {d}_{H}}{\text{?} {s}_{F}} \frac{\sqrt{3}}{2} b \qquad ( 6 )$$

$$\text{?} \text{indicates text missing or illegible when filed}$$

The first area includes six first sub-areas each being perpendicular to the sides of the hexagonal interior area and extending to the outside of the hexagonal interior area. The six first sub-areas, for example, include sub-area I, sub-area II, sub-area III, sub-area IV, sub-area V and sub-area VI; the second area includes six second sub-areas that are separated by the six first sub-areas respectively. For instance, the six second sub-areas include sub-area Z1, sub-area Z2, sub-area Z3, sub-area Z4, sub-area Z5 and sub-area Z6.

The stator current measurement data iₖ contain a D-axis component i_{d} and a Q-axis component i_{q}. Correspondingly, the current following error signal x₀ has a D-axis component x_{d} and a Q-axis component x_{q}, wherein x_{d}=i_{d}−ī_{d} and x_{q}=i_{q}−ī_{q}. ī_{d} is the D-axis component of the steady-state current ī and ī_{q} is the Q-axis component of the steady-state current ī.

In accordance with the D-axis component x_{d} and the Q-axis component x_{q} of the current following error signal xₖ, the computing device determines whether the area where the current following error signal is located in the current plane state partition is a hexagonal interior area, a first area or a second area.

At step 208, if it is determined that the area where the current following error signal is located in the current plane state partition is the first area, the computing device maps the current following error signal to a side of the first area, to obtain the updated current following error signal.

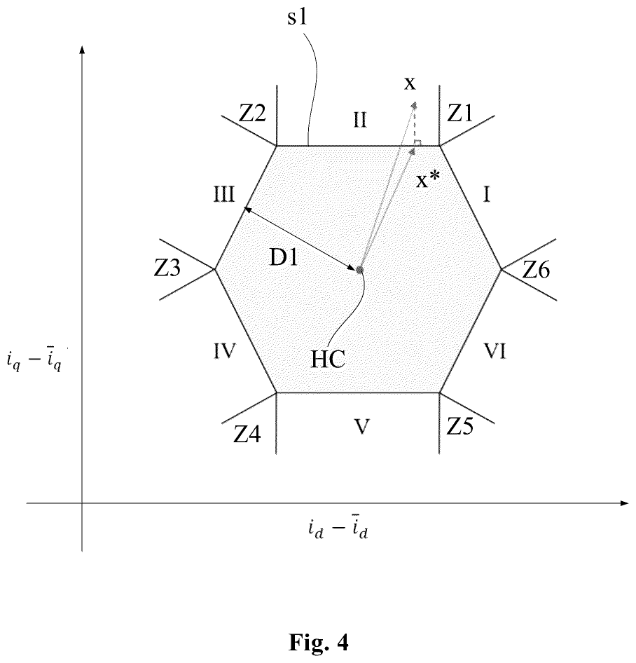

FIG. 4 illustrates a schematic diagram in which the current following error signal is located in the first area in accordance with the embodiments of the present disclosure. Referring to FIG. 4, the current following error signal x is in a sub-area II and the computing device determines that the area where the current following error signal x is located in the current plane state partition is the first area. Accordingly, the computing device maps the current following error signal x to a side of the first area to obtain the updated current following error signal x*. It is to be understood that the mapping of the current following error signal x to a side of the first area for example includes: drawing a line perpendicular to the side s1 of the first area from the current following error signal x in the two-phase rotating coordinate system, to obtain data x* corresponding to the foot of the perpendicular (e.g., a point corresponding to x* in the figure) as the updated current following error signal. In other words, the updated current following error signal x* is the vertical projection (i.e., orthogonal projection) of the current following error signal x along a normal vector of the corresponding side s1 of the sub-area II. It is to be appreciated that when the updated current following error signal is obtained by mapping the current following error signal to a side of the first area, the algorithm for obtaining the updated current following error signal is effectively simplified, the computation work is reduced and the efficiency is enhanced.

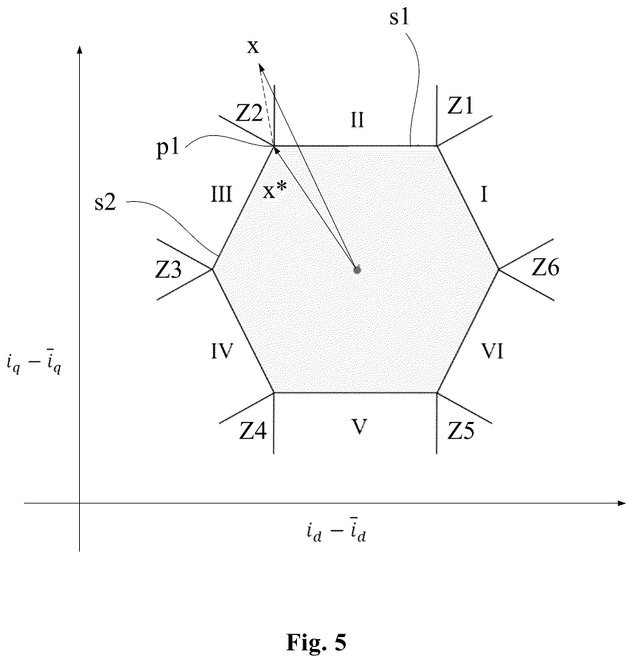

At step 210, if it is determined that the area where the current following error signal is located in the current plane state partition is the second area, the computing device obtains the updated current following error signal based on a vertex where two corresponding sides of the hexagonal interior area intersect. FIG. 5 illustrates a schematic diagram in which the current following error signal is located in the second area in accordance with the embodiments of the present disclosure. Referring to FIG. 5, the current following error signal x is located in the sub-area Z2, and the computing device determines that the area where the current following error signals x are located in the current plane state partition is the second area. Accordingly, the computing device obtains the updated current following error signal x* based on a vertex where two corresponding sides of the hexagonal interior area H1 intersect. It is to be understood that a vertex p1 corresponding to the updated current following error signal x* is the vertex where two corresponding sides of the hexagonal interior area H1 intersect, wherein the two corresponding sides respectively are side s1 and side s2 of the hexagonal interior area H1. It is appreciated that the vertex p1 corresponding to the updated current following error signal x* is the corresponding vertex p1 of the sub-area Z2 where the current following error signal x is located, i.e., the vertex of the hexagonal interior area H1 closest to the current following error signal x. It is to be understood that a determined corresponding relation exists between the vertex p1 and the sub-area Z2. Further, after the current plane state partition is built, the value corresponding to the vertex x1 is also determined. Therefore, once determining that the current following error signal x is in the sub-area Z2, the computing device may determine the value of the updated current following error signal x* in accordance with a corresponding relation between the vertex p1 and the sub-area Z2 without requiring additional data computation. This is highly efficient.

At step 212, the computing device generates the current loop control voltage for controlling the stator current of the permanent magnet synchronous motor based on the updated current following error signal, to cause the stator current of the permanent magnet synchronous motor to track the reference current.

In some embodiments, the generating the current loop control voltage for controlling the stator current of the permanent magnet synchronous motor based on the updated current following error signal, for example, includes: introducing the updated current following error signal x* into the following Equation (7) to obtain the current loop control voltage:

$$\text{?} = - \text{?} [ {r}^{2} {s}_{F}^{4} + {r}^{2} {s}_{F}^{2} + 2 {rs}_{F}^{2} + {( r + 1 )}^{2} ] R ( - ω \text{?} - \text{?} ) \text{?} \qquad ( 7 )$$

$$\text{?} \text{indicates text missing or illegible when filed}$$

### Where

$$\text{?}$$

$$\text{?} \text{indicates text missing or illegible when filed}$$

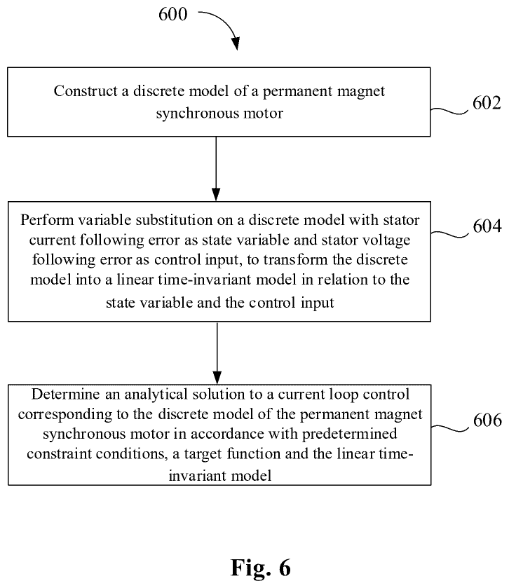

represents the current loop control voltage; s_{F} denotes the scaling factor of the system matrix; d_{H} refers to the square root of the determinant of an inverse matrix H⁻¹ of the matrix H; θ_{B} indicates the rotation angle; r is the penal weight of the control input vₖ; R represents the penalty matrix of the control input vₖ; ω refers to the rotation speed of the permanent magnet synchronous motor; Tₛ and indicates the sampling time of the permanent magnet synchronous motor. The control input vₖ for example is the stator voltage following error, i.e., a difference value between the stator voltage measurement data vₖ at the sampling time and the steady-state voltage ū of the permanent magnet synchronous motor. That is vₖ=uₖ−ū.

Wherein the Equation (7) is an analytical solution to the current loop control corresponding to the discrete model of the permanent magnet synchronous motor based on the model predictive control. The analytical solution to the current loop control corresponding to the discrete model of the permanent magnet synchronous motor, for example, may be determined by: constructing the discrete model of the permanent magnet synchronous motor; performing variable substitution on the discrete model with the stator current following error as the state variable and the stator voltage following error as the control input, to transform the discrete model into a linear time-invariant model in relation to state variable and control input; and determining the analytical solution to the current loop control corresponding to the discrete model of the permanent magnet synchronous motor based on the predetermined constraint conditions, the target function and the linear time-invariant model. The method for determining the analytical solution to the current loop control corresponding to the discrete model of the permanent magnet synchronous motor is to be explained in details below with reference to FIG. 6 and will not be elaborated here.

At step 214, if it is determined that the area where the current following error signal is located in the current plane state partition is the hexagonal interior area, the computing device generates the current loop control voltage for controlling the stator current of the permanent magnet synchronous motor based on the current following error signal, to cause the stator current of the permanent magnet synchronous motor to track the reference current. In other words, if the area where the current following error signal is located in the current plane state partition is the hexagonal interior area, the computing device generates the current loop control voltage for controlling the stator current of the permanent magnet synchronous motor directly based on the current following error signals.

In some embodiments, the generating the current loop control voltage for controlling the stator current of the permanent magnet synchronous motor based on the current following error signals, for example, includes: introducing the current following error signal into the Equation (7) to obtain the current loop control voltage, wherein the value of the variable x* in the Equation (7) is the current following error signal obtained by the computing device.

Based on the above solution, the corresponding current following error signal is determined according to the stator current measurement data, so as to determine the updated current following error signal on the basis of the current following error signal. Furthermore, in the above solution, by building the hexagonal interior area characterizing the current vector locus boundary and dividing the first area and the second area surrounding the hexagonal interior area, the area where the current following error signal is located is conveniently and rapidly determined, so as to quickly determine the updated current following error signal. Specifically, when the area where the current following error signal is located in the current plane state partition is the hexagonal interior area, the current loop control voltage is calculated directly based on the current following error signal via the Equation (7); when the current following error signal is in the first area, the current following error signal is mapped to the side of the first area to obtain the updated current following error signal, and the current loop control voltage for controlling the stator current of the permanent magnet synchronous motor is generated based on the updated current following error signal, to cause the stator current of the permanent magnet synchronous motor to track the reference current; when the current following error signal is in the second area, the updated current following error signal is obtained based on the vertex where the two corresponding sides of the hexagonal interior area intersect, so as to generate the current loop control voltage for controlling the stator current of the permanent magnet synchronous motor. In particular, in case that the area where the current following error signal is located in the current plane state partition is the first area, the updated current following error signal is obtained by mapping the current following error signal to the side of the first area, which may significantly lower the complexity of the computation and reduce the computation work. In summary, the above solution can quickly obtain the current loop control voltage for controlling the stator current of the permanent magnet synchronous motor while avoiding a complicated process for solving the optimization problem corresponding to the current tracking problem and the massive computation work in the current loop control procedure. Provided with the computing device having equivalent computing power, it takes about 100 microseconds for the traditional solution to complete the computation required for the current loop control while the time is reduced to about 5 microseconds in the above solution of the present disclosure. The speed is increased remarkably. Moreover, as the computation complexity is lowered and the computation load is significantly reduced, the use of the computation resources is also remarkably decreased.

FIG. 6 illustrates a flowchart of a method 600 for determining an analytical solution to the current loop control corresponding to the discrete model of the permanent magnet synchronous motor in accordance with embodiments of the present disclosure. The method 600 may be executed by the computing device 120 shown in FIG. 1 and also may be executed at the electronic device 1000 illustrated in FIG. 10. It is to be understood that the method 600 also may include additional steps not shown and/or omit the illustrated steps. The scope of the present disclosure is not restricted in this regard.

At step 602, the computing device constructs the discrete model of the permanent magnet synchronous motor.

In some embodiments, the discrete model of the permanent magnet synchronous motor built by the computing device is illustrated by the above-mentioned Equation (2):

iₛ(k+1)=Fiₛ(k)+Biₛ(k)+g (2)

At step 604, the computing device performs variable substitution on the discrete model with the stator current following error as the state variable and the stator voltage following error as the control input, to transform the discrete model into a linear time-invariant model in relation to state variable and control input.

In some embodiments, the system matrix F may be represented by the following Equation (8):

$$F = {e}^{- \frac{{R}_{s} {T}_{s}}{{L}_{s}}} [ \begin{matrix}cos ω {T}_{s} & sin ω {T}_{s} \\ - sin ω {T}_{s} & cos ω {T}_{s}\end{matrix} ] = {s}_{F} R ( - ω {T}_{s} ) \qquad ( 8 )$$

Where s_{F} indicates the scaling factor corresponding to the system matrix F; R denotes the penalty matrix. Likewise, the input matrix B may be represented by the following Equation (9):

B=s_{B}R(θ_{B}) (9)

Where s_{B} indicates the scaling factor corresponding to the input matrix B and θ_{B} denotes the feature rotating angle of the input matrix B.

Therefore, the system matrix F and the input matrix B are scaling rotation matrices and are commutative, i.e., FB=BF.

In terms of the discrete model shown in the Equation (2), the discrete model in the steady state satisfies i=Fi+Bū+g, i.e., ū=B⁻¹|(I−F)i−g|. The following Equation (10) may be derived from the Equation (2):

(iₖ₊₁−ī)=F(iₖ−ī)+B(uₖ−ū) (10)

As to Equation (10), the computing device performs variable substitution on the Equation (10) with the stator current following error as the state variable and the stator voltage following error as the control input, to transform the discrete model into a linear time-invariant model in relation to state variable and control input.

For example, it is set that the state variable xₖ=iₖ−ī and the control input vₖ=uₖ−ū. After the variable substitution, the Equation (10) is transformed into the following Equation (11):

xₖ₊₁=Fxₖ+Bvₖ (11)

It is to be appreciated that the Equation (11) characterizes the linear time-invariant model in relation to the state variable xₖ and the control input vₖ.

At step 606, the computing device determines the analytical solution to the current loop control corresponding to the discrete model of the permanent magnet synchronous motor based on the predetermined constraint conditions, the target function and the linear time-invariant model.

The predetermined constraint conditions, for example, include constraint conditions about the control input (i.e., stator voltage following error) and the constraint conditions with respect to the state variable (i.e., stator current following error).

The predetermined constraint conditions, for example, include constraint conditions with respect to an original voltage of a permanent magnet synchronous motor, a steady-state voltage of a permanent magnet synchronous motor, a bus voltage of a permanent magnet synchronous motor and a penalty matrix of the control input.

The target function, for example, includes target function J₀, which may refer to the function shown in Equation (15) and will not be repeated here.

In the driving system of the permanent magnet synchronous motor, the original control input uₖ (i.e., stator voltage measurement data of the permanent magnet synchronous motor) is constrained by voltage hexagon. For example, with respect to the model predictive controller having a predicted step of Nₚ, its control input uₖ is constrained by the following Equation (12):

$$A \text{?} {v}_{0} \leq {b}_{u} - A \text{?} u \text{?} = {b}_{u} - A \text{?} R ( {θ}_{r} ) u \text{?} = b \text{?} \qquad ( 12 )$$

$$A \text{?} {v}_{1} \leq {b}_{u} - A \text{?} u \text{?} = {b}_{u} - {A}_{u} R ( {θ}_{r} + ω T \text{?} ) u \text{?} = b \text{?}$$

$$A \text{?} {v}_{2} \leq {b}_{u} - A \text{?} u \text{?} = {b}_{u} - {A}_{u} R ( {θ}_{r} + 2 ω T \text{?} ) u \text{?} = b \text{?}$$

$$\text{?} \text{indicates text missing or illegible when filed}$$

### Where

$$R ( {θ}_{r} + k ω T \text{?} ) = [ \begin{matrix}cos ( {θ}_{r} + k ω T \text{?} ) & sin ( {θ}_{r} + k ω T \text{?} ) \\ - sin ( {θ}_{r} + k ω T \text{?} ) & cos ( {θ}_{r} + k ω T \text{?} )\end{matrix} ] ,$$

$${A}_{v}^{k} = {A}_{u} R ( {θ}_{r} + k ω {T}_{s} ) ,$$

$$\text{?} \text{indicates text missing or illegible when filed}$$

k=1, . . . , s; ū represents the steady-state voltage of the permanent magnet synchronous motor; R denotes the penalty matrix of the control input; θᵣ indicates the rotor angle of the permanent magnet synchronous motor; v₀ refers to the initial value of the control input; and ω is the rotation speed of the permanent magnet synchronous motor.

In some embodiments, the original current iₖ (i.e., stator current measurement data of the permanent magnet synchronous motor) is constrained by the current circle (a circular area for constraining currents), i.e., ∥iₖ∥₂≤Iₘₐₓ, wherein Iₘₐₓ characterizes the maximum current value of the stator current measurement data for constraining the original current.

In some embodiments, the current circle is approximated by the Nᵢ polygon characterized by Aᵢiₛ≤bᵢ; Aᵢ∈ [symbol] ^{H}^{ᵢ}^{×2} to form the constraints over the original current iₖ, wherein,

$${A}_{i}^{k} = [ cos \frac{2 k + 1}{12} sin \frac{2 k + 1}{12} ] , k = 0 , … , {N}_{i} - 1$$

Nᵢ is an integer greater than or equal to 6; Nᵢ the polygon is a regular polygon. As the value of Nᵢ increases, the Nᵢ polygon gets closer to the current circle.

Correspondingly, the state variable xₖ is constrained by the following Equation (13):

Aᵢxₖ=Aᵢiₖ−Aᵢī≤bᵢ−Aᵢī≙bₓ (13)

Wherein ī indicates the steady-state current of the permanent magnet synchronous motor, bᵢ=Iₘₐₓ1, in which Iₘₐₓ characterizes the maximum current value for constraining the original current and 1 denotes a column vector with elements all being 1.

In case that the initial state of the state variable of the permanent magnet synchronous motor is x₀ and the control input sequence is

$${V}_{0}^{T} = \{ {v}_{0}^{T} , {v}_{1}^{T} , {v}_{2}^{T} … \} ,$$

the state variable xₖ is transformed according to the following equation (14):

$$[ \begin{matrix}x \text{?} \\ x \text{?} \\ x \text{?} \\ ⋮\end{matrix} ] = [ \begin{matrix}F \text{?} \\ F \text{?} \\ F \text{?} \\ ⋮\end{matrix} ] \text{?} + [ \begin{matrix}B & 0 & 0 & \\ FB & B & 0 & \\ {F}^{2} B & FB & B & \\ & & & ⋱\end{matrix} ] [ \begin{matrix}{v}_{0} \\ {v}_{1} \\ {v}_{2} \\ ⋮\end{matrix} ] \qquad ( 14 )$$

$$\text{?} \text{indicates text missing or illegible when filed}$$

### Where

$$X = [ \begin{matrix}{x}_{1} \\ {x}_{2} \\ {x}_{3} \\ ⋮\end{matrix} ] , S \text{?} [ \begin{matrix}F \\ {F}^{2} \\ {F}^{3} \\ ⋮\end{matrix} ] , S \text{?} = [ \begin{matrix}B & 0 & 0 & \\ FB & B & 0 & \\ {F}^{2} B & FB & B & \\ & & & ⋱\end{matrix} ] , {V}_{0} = [ \begin{matrix}{v}_{0} \\ {v}_{1} \\ {v}_{2} \\ ⋮\end{matrix} ] ,$$

$$\text{?} \text{indicates text missing or illegible when filed}$$

i.e., X=Sₓx₀+SᵤV₀.

Accordingly, the target function J₀ in the Equation (5) may be represented by the following Equation (15):

$${J}_{0} = \frac{1}{2} {V}_{0}^{T} H {V}_{0} + {x}_{0}^{T} M {V}_{0} + \frac{1}{2} {x}_{0}^{T} Y {x}_{0} \qquad ( 15 )$$

### Where

$$H = \frac{1}{{s}_{B}^{2}} {S}_{u}^{T} {S}_{u} + rI , M = \frac{1}{{s}_{B}^{2}} {S}_{x}^{T} {S}_{u} ;$$

r is the penalty weight of the control input vₖ; s_{B} represents the scaling factor of the input matrix B; I refers to the unit matrix; wherein the penalty weight r denotes a proportion of a difference between the actual control input and the target value in the entire target function or the cost function. With a small penalty weight r, the control input is allowed to vary to a greater extent and the corresponding system dynamic response becomes more rapidly; and vice versa.

Correspondingly, the optimization problem illustrated in the Equation (5) is reconstructed into the updated optimization problem shown in the following Equation (16):

$$min {J}_{0} = \frac{1}{2} {V}_{0}^{T} H {V}_{0} + {x}_{0}^{T} M {V}_{0} + \frac{1}{2} {x}_{0}^{T} Y {x}_{0} \qquad ( 16 )$$

$$s . t . {GV}_{0} \leq {Ex}_{0} + ω$$

$${x}_{0} = i ( 0 ) - \overline{i}$$

### Where

$$G = [ \begin{matrix}{A}_{v} \\ 0 \\ ( {I}_{N} ⊗ {A}_{i} ) {S}_{u}\end{matrix} ] , E = [ \begin{matrix}{0}_{N} \\ - {A}_{i} \\ - ( {I}_{N} ⊗ {A}_{i} ) {S}_{x}\end{matrix} ] ,$$

$$ω = [ \begin{matrix}{1}_{N} ⊗ {b}_{u} - {A}_{v} ( {1}_{N} ⊗ \overline{u} ) \\ {b}_{x} \\ {1}_{N} ⊗ {b}_{x}\end{matrix} ] .$$

According to the Equation (16), the analytical solution to the optimization problem shown in the Equation (16) can be found.

To facilitate description, the updated optimization problem shown in the Equation (16) is referred to as “optimization problem (16)”.

When the optimization problem (16) is non-constrained, its analytical solution is shown by the following Equation (17):

$${V}_{0}^{*} = - {H}^{- 1} {M}^{T} {x}_{0} \qquad ( 17 )$$

When the optimization problem (16) is non-constrained, only the first step V₀* is selected in accordance with the model predictive control theory as the predicted control rate to perform current loop control, wherein the predicted control rate is the current loop control voltage for controlling the stator current of the permanent magnet synchronous motor obtained from the Equation (7);

$${v}_{0}^{*} = - \frac{{s}_{F}}{{s}_{B} {d}_{H}} [ {r}^{2} {s}_{F}^{4} + {r}^{2} {s}_{F}^{2} + 2 {rs}_{F}^{2} + {( r + 1 )}^{2} ] R ( - ω {T}_{s} - {θ}_{B} ) {x}^{*} \qquad ( 7 )$$

Where s_{F} refers to the scaling factor of the system matrix F; d_{H} denotes a square root of a determinant of an inverse matrix H⁻¹ of the matrix; θ_{B} characterizes the feature rotating angle of the input matrix B; and x* represents the updated current following error signal.

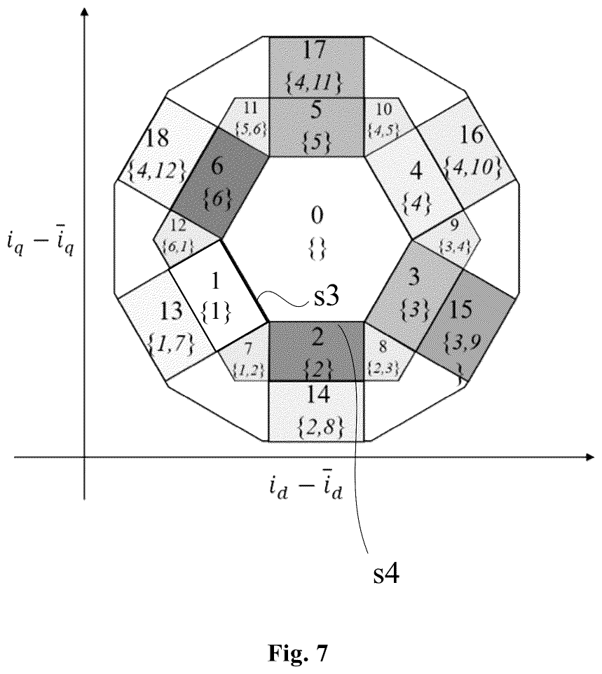

It is to be appreciated that when the optimization problem (16) is constrained, the present disclosure divides the current plane in accordance with the number of constraints being satisfied, as illustrated in FIG. 7. FIG. 7 illustrates a schematic diagram of the current plane state partition in accordance with embodiments of the present disclosure, wherein numbers in the braces “{ }” represent the constraint number of the inequality constraint in which the equality holds in the optimization problem (16). It is to be understood that the set of inequalities GV₀≤Ex₀+ω in the optimization problem (16) includes a plurality of inequality constraints. For example, if a condition corresponding to the equal sign in the k-th inequality constraint holds, it indicates that “the equality of the m-th inequality constraint holds” and the corresponding “constraint number” is m. For instance, as shown in FIG. 7, area 0 represents non-constrained case; and area 1 indicates that the equality of the first inequality constraint holds. As such, the constraint number 1 marked in the brace “{ }” of the area 1 represents that the equal sign of the first inequality constraint holds when the current following error signal is in the area 1. Likewise, the area 13 corresponds to the constraint numbers 1 and 7; and the wedge area 7 corresponds to the constraint numbers 1 and 2. The constraint numbers for other areas may refer to FIG. 7 and will not be elaborated here.

It is demonstrated that the current plane state partition (critical region) corresponding to the non-constrained optimization problem (16) is the hexagonal interior area corresponding to area 0 (i.e., hexagonal interior area H1).

In case that the optimization problem (16) only has one control constraint (i.e., the equal sign of only one inequality constraint holds), it is demonstrated that the control constraint at the first step is always satisfied first. In such case, the current plane state partition corresponding to the optimization problem (16) is areas formed by lines extending perpendicularly outward along the six sides of the hexagonal interior region determined in the non-constrained case, i.e., areas 1-6 in FIG. 7.

When the optimization problem (16) has two control constraints (i.e., the equal signs of two inequality constraints hold), the following two situations may occur.

In the first situation, taking the rectangular area indicated as area 13 as an example, in case that the current following error signal is in the area 13, if the control constraint corresponding to one side of the voltage hexagon can satisfy the equality of the inequality constraint in two consecutive steps

$$( i . e . , {v}_{0}^{*} and {v}_{1}^{*} ) ,$$

this side is the corresponding side s3 of the area 1. It is demonstrated that the area 13 is an area that extends perpendicularly towards the outside of the voltage hexagon along the area 1. Areas 14-18 are similar to the area 13 and belong to the above first situation, so they will not be elaborated here. Areas 14-18 are areas that extend perpendicularly towards the outside of the voltage hexagon along the areas 2-6 respectively. That is, in the first situation, the current plane state partition of the optimization problem (16) includes six areas, i.e., areas 13-18.

In the second situation, taking the wedge area denoted as area 7 as an example, in case that the current following error signal is in the area 7, if the control constraints corresponding to the two sides of the voltage hexagon can satisfy the equality of the inequality constraint at the same step

$${v}_{0}^{*} ,$$

the two sides are the side s3 corresponding to the area 1 and the side s4 corresponding to the area 2. Areas 8-12 are similar to the area 7 and belong to the above second situation, so they will not be elaborated here. That is, in the second situation, the current plane state partition of the optimization problem (16) includes six areas, i.e., areas 7-12.

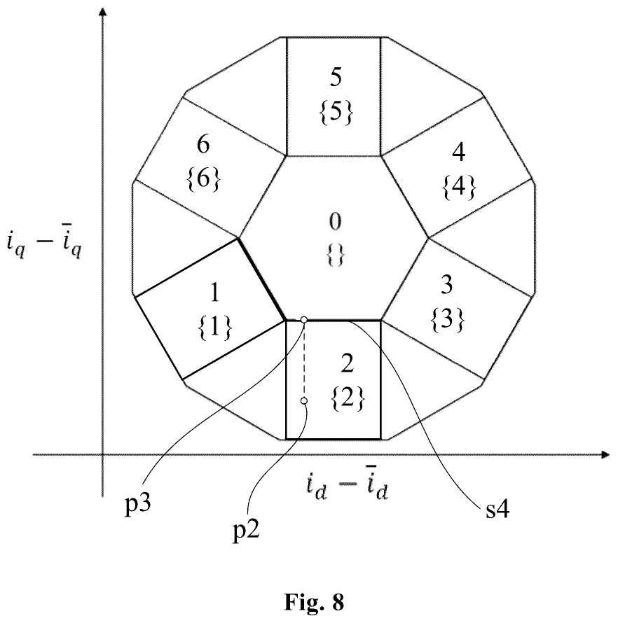

FIG. 8 illustrates another schematic diagram of the current plane state partition in accordance with embodiments of the present disclosure. It is demonstrated that when the optimization problem (16) only has one control constraint, e.g., the current following error signal is at the position p2 of the area 2 in FIG. 8, the corresponding constrained predictive control rate is equal to the non-constrained predictive control rate corresponding to the position p3 of the area 0, wherein the position p3 is the vertical projection of the position p2 along a normal vector of the side s4 of the hexagonal interior area (i.e., side s4 corresponding to the area 2). Areas 1 and 3-6 shown in FIG. 8 are identical to the area 2 in this regard and will not be elaborated here.

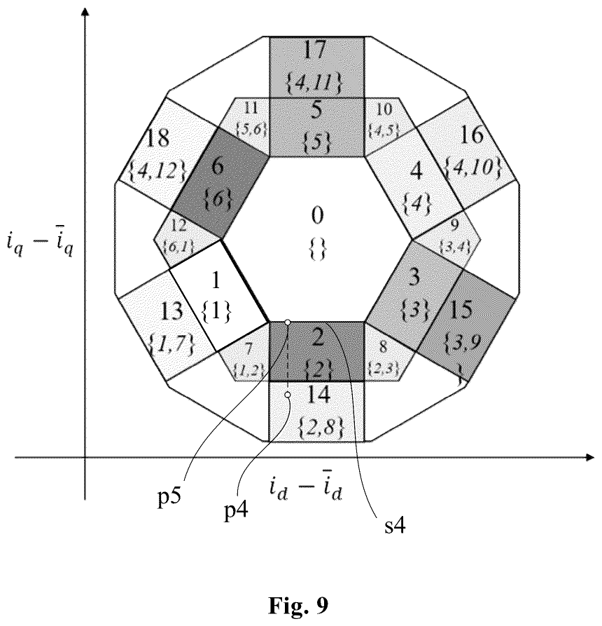

FIG. 9 illustrates a further schematic diagram of the current plane state partition in accordance with embodiments of the present disclosure. It is demonstrated that when the optimization problem (16) only has two control constraints, e.g., the current following error signal is at the position p4 of the area 14 in FIG. 9, the corresponding constrained predictive control rate is equal to the non-constrained predictive control rate corresponding to the position p5 of the area 0, wherein the position 5 is the vertical projection of the position p4 along a normal vector of the side s4 of the hexagonal interior area (i.e., side s4 corresponding to the area 14). Areas 13 and 15-18 shown in FIG. 9 are identical to the area 14 in this regard and will not be elaborated here.

By this analogy, when the optimization problem (16) has any number of control constraints, the current plane state partition may be divided into the area distribution shown in FIG. 3: the current hexagonal interior area, the first area (collectively formed by sub-area I, sub-area II, sub-area III, sub-area IV, sub-area V and sub-area VI) and the second area (collectively formed by sub-area Z1, sub-area Z2, sub-area Z3, sub-area Z4, sub-area Z5 and sub-area Z6).

Wherein in case that the current following error signal is in the first area, the computing device maps the current following error signal to a side of the first area to obtain the updated current following error signal. Then, the updated current following error signal is introduced into the Equation (7) to obtain the predicted control rate, i.e., the corresponding current loop control voltage for controlling the stator current of the permanent magnet synchronous motor is obtained. In case that the current following error signal is in the second area, the computing device obtains the updated current following error signal based on a vertex where two corresponding sides of the hexagonal interior area intersect, and introduces the updated current following error signal into the Equation (7) to obtain the predicted control rate, i.e., the corresponding current loop control voltage for controlling the stator current of the permanent magnet synchronous motor is obtained. In case that the current following error signal is in the hexagonal interior area, the computing device directly introduces the current following error signal into the Equation (7) (wherein the value of the variable is the current following error signal obtained by the computing device), i.e., the corresponding current loop control voltage for controlling the stator current of the permanent magnet synchronous motor is obtained.

In essence, the optimization problem (16) is a complicated constrained optimization problem, and it requires massive computing resources to solve the problem. The present disclosure obtains the analytical solution (i.e., Equation (7)) to the optimization problem (16) through analysis. As such, based on the current data acquired from sampling alone, the predictive control rate of the constrained optimization problem can be rapidly obtained as the current loop control voltage for controlling the stator current of the permanent magnet synchronous motor, which current loop control voltage is used for the current loop control. Accordingly, the process of solving the problem through the complicated online optimization algorithm is omitted. In view of the technical solution of the present disclosure, the constrained predictive control algorithm can be implemented on low and medium end control chips, which can greatly improve the dynamic response performance of the motor and achieve rapid and efficient control performance.

FIG. 10 illustrates a schematic block diagram of an example electronic device 1000 for implementing the method for controlling currents of permanent magnet synchronous motors based on constrained model predictive control in accordance with embodiments of the present disclosure. As shown in FIG. 10, the electronic device 1000 comprises a central process unit (i.e., CPU 1001), which can execute various suitable actions and processing based on the computer program instructions stored in the read-only memory (i.e., ROM 1002) or computer program instructions loaded in the random-access memory (i.e., RAM 1003) from the storage unit 1008. The RAM 1003 can also store all kinds of programs and data required by the operation of the electronic device 1000. CPU 1001, ROM 1002 and RAM 1003 are connected to each other via a bus 1004. The input/output interface (i.e., I/O interface 1005) is also connected to the bus 1004.

A plurality of components in the electronic device 1000 is connected to the I/O interface 1005, including: an input unit 1006, such as keyboard, mouse, microphone and the like; an output unit 1008, e.g., various kinds of display and loudspeakers etc.; a storage unit 1008, such as disk and optical disk etc.; and a communication unit 1009, such as network card, modem, wireless transceiver and the like. The communication unit 1009 allows the electronic device 1000 to exchange information/data with other devices via the computer network, such as Internet, and/or various telecommunication networks.

The above described procedure and processing, such as methods 200 and 600, can be executed by the CPU 1001. For example, in some embodiments, methods 200 and 600 can be implemented as a computer software program tangibly included in the machine-readable medium, e.g., storage unit 1008. In some embodiments, the computer program can be partially or fully loaded and/or mounted to the electronic device 1000 via ROM 1002 and/or communication unit 1009. The computer program, when loaded to RAM 1003 and executed by the CPU 1001, can perform one or more actions of the above described methods 200 and 600.

The present disclosure relates to method, apparatus, system, electronic device, computer-readable storage medium and/or computer program product. The computer program product may include computer-readable program instructions for executing various aspects of the present disclosure.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge computing device. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

1. A method of controlling currents of a permanent magnet synchronous motor based on constrained model predictive control, comprising:
obtaining stator current measurement data of the permanent magnet synchronous motor at sampling time;
generating a current following error signal based on the stator current measurement data and a stator current set value;
determining whether an area where the current following error signal is located in a current plane state partition is a hexagonal interior area, a first area or a second area, the current plane state partition including the hexagonal interior area, and the first area and the second area surrounding the hexagonal interior area, the hexagon being a regular hexagon, the first area comprising six first sub-areas being perpendicular to sides of the hexagonal interior area and extending towards outside of the hexagonal interior area respectively, and the second area comprising six second sub-areas separated by the six first sub-areas respectively;
in response to determining that the area where the current following error signal is located in the current plane state partition is the first area, mapping the current following error signal to a side of the first area to obtain an updated current following error signal; and
generating, based on the updated current following error signal, a current loop control voltage for controlling a stator current of the permanent magnet synchronous motor, to cause the stator current of the permanent magnet synchronous motor to track a reference current.

2. The method of claim 1, further comprising:
in response to determining that the area where the current following error signal is located in the current plane state partition is the second area, obtaining the updated current following error signal based on a vertex where corresponding two sides of the hexagonal interior area intersect, to generate the current loop control voltage for controlling the stator current of the permanent magnet synchronous motor.

3. The method of claim 1, further comprising:
in response to determining that the area where the current following error signal is located in the current plane state partition is the hexagonal interior region, generating the current loop control voltage for controlling the stator current of the permanent magnet synchronous motor based on the current following error signal, to cause the stator current of the permanent magnet synchronous motor to track the reference current.

4. The method of claim 1, wherein generating the current loop control voltage for controlling the stator current of the permanent magnet synchronous motor comprises:
generating, based on the updated current following error signal, the current loop control voltage for controlling the stator current of the permanent magnet synchronous motor, via an analytical solution to a current loop control corresponding to a discrete model of the permanent magnet synchronous motor.

5. The method of claim 4, wherein the analytical solution to the current loop control corresponding to the discrete model of the permanent magnet synchronous motor is determined by the following steps:
constructing the discrete model of the permanent magnet synchronous motor;
performing variable substitution on the discrete model with stator current following error as state variable and stator voltage following error as control input, to transform the discrete model into a linear time-invariant model in relation to the state variable and the control input; and
determining the analytical solution to the current loop control corresponding to the discrete model of the permanent magnet synchronous motor in accordance with predetermined constraint conditions, a target function and the linear time-invariant model.

6. The method of claim 5, wherein the predetermined constraint conditions include constraint conditions with respect to an original voltage of the permanent magnet synchronous motor, a steady-state voltage of the permanent magnet synchronous motor, a bus voltage of the permanent magnet synchronous motor and a penalty matrix of the control input.

7. (canceled)

8. The method of claim 1, wherein the stator current set value comprises steady-state current data of the permanent magnet synchronous motor.

9. The method of claim 5, wherein a system state matrix and an input matrix of the discrete model of the permanent magnet synchronous motor are both scaling rotation matrices.

10. A computing device, comprising:
at least one processor; and
a memory communicatively connected to the at least one processor;
wherein the memory stores instructions that can be executed by the at least one processor, the instructions, when executed by the at least one processor, causing the at least one processor to perform the method according to claim 1.

11. A computer-readable storage medium, wherein the computer-readable storage medium is stored with computer programs thereon, and wherein the computer programs, when executed by a machine, implement the method according to claim 1.
